(19) United States
(12) Patent Application Publication
(10) Pub. No.: US 2007/0265163 A1
(43) Pub. Date: Nov. 15, 2007

(54) Thermally Sensitive Recording Medium

(76) Inventors: Takashi Date, Tokyo (JP); Mizuho Shimoyama, Tokyo (JP); Koichi Yanai, Tokyo (JP); Kenji Hirai, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/663,229

(22) PCT Filed: Sep. 30, 2005
(86) PCT No.: PCT/JP05/18592

§ 371 Date: Mar. 19, 2007

(30) Foreign Application Priority Data
Sep. 30, 2004 (JP) 2004-288398

(51) Int. Cl. B41M 5/26

(52) U.S. Cl. 503/207; 503/225

(57) ABSTRACT

A thermally sensitive recording medium comprising, single or multi layers, wherein, at least one layer on a substrate is a thermally sensitive recording layer that contains a colorless or pale colored electron donating leuco dye and an electron accepting color developing agent, further, at least one layer on the substrate contains hydrated silicic acid compound which is treated by wet grinding treatment in deposition process of the hydrated silicic acid compound, thus, obtain a thermally sensitive recording medium of high brightness, which is superior in color developing sensitivity and coating layer strength, further excellent in head abrasion resistance, less debris adhering and sticking resistance

### FIELD OF THE INVENTION

The present invention relates to a thermally sensitive recording medium which utilizes color developing reaction of a basic colorless dye with an organic color developing agent.

### BACKGROUND OF THE INVENTION

A thermally sensitive recording medium having a thermally sensitive recording layer (called as a thermally sensitive color developing layer or a thermally sensitive layer) containing a colorless or pale colored dye precursor and a color developing agent which develops color by thermal reaction with the colorless or pale colored dye precursor as main components was disclosed in Japanese Patent S45-14039 B publication and is widely utilized. A thermal printer in which a thermal head is built in is used to record images on the thermally sensitive recording medium, and when compared with the conventional recording method, this thermally sensitive recording method has advantages that noiseless at recording process, developing process and fixing process are not necessary, maintenance free, an apparatus is relatively cheap and compact, and an obtained color is very clear, therefore, is widely applied as recording papers for industrial information such as a facsimile, a terminal printer of computer, a recorder for measuring instrument or a label. Recently, the uses are becoming diversified, and along with the diversification of uses, a recording instrument are becoming compact and high speed. Accordingly, a thermally sensitive recording medium that clear developed image can be obtained by small thermal energy is desired.

For the purpose to satisfy the requirement, a method to enhance color developing sensitivity by adding thermal fusible substance in a thermally sensitive recording layer (Patent Document 1), a method to enhance color developing sensitivity by using novel color developing agent having high color developing ability and a method to combine specific color developing agent and specific sensitizer (Patent Document 2, Patent Document 3 and Patent document 4) are disclosed, however, problems such as deterioration of heat resistance of ground color, powdering by time lapse, deterioration of re-printing ability, deterioration of debris adhering resistance or deterioration of sticking resistance cause. In particular, deterioration of debris adhering resistance and deterioration of sticking resistance are becoming big problems. Said deterioration of debris adhering resistance and deterioration of sticking resistance are caused by fusing and adhering of components contained in a thermally sensitive color developing layer by heat from a thermal head. Aiming to dissolve said problems, a method to contain fine particles of amorphous silica having specific particle size distribution, specific BET surface area and bulk density (Patent Document 5) is disclosed, however, because surface activity of silica promotes reaction between leuco dye and a color developing agent, problem of ground color developing (background coloring) is arisen. Further, in the case when ordinary silica is used, since surface strength (coating layer strength) of a thermally sensitive recording medium is deteriorated, not only a problem of stain of a blanket is arisen at offset printing, but also head abrasion resistance is deteriorated.

(Patent Document 1) JP S56-169087 A publication

(Patent Document 2) JP S56-144193 A publication

(Patent Document 3) JP S60-82382 A publication

(Patent Document 4) JP S57-201691 A publication

(Patent Document 5) JP S58-87094 A publication

### DISCLOSURE OF THE INVENTION

The object of the present invention is to provide a thermally sensitive recording medium of high brightness, which is superior in color developing sensitivity and coating layer strength, further excellent in head abrasion resistance, less debris adhering and sticking resistance.

According to the earnest investigation of the inventors, the object of the present invention mentioned above is dissolved by a thermally sensitive recording medium comprising, single or multi layers, wherein, at least one layer on a substrate is a thermally sensitive recording layer that contains a colorless or pale colored electron donating leuco dye and an electron accepting color developing agent, further, at least one layer on the substrate contains hydrated silicic acid compound which is treated by wet grinding treatment in deposition process of the hydrated silicic acid compound.

### DESCRIPTION OF THE PREFERRED EMBODIMENT

The thermally sensitive recording medium of the present invention can contain hydrated silicic acid compound, which is treated by wet grinding treatment in hydrated silicic acid compound deposition process, in a thermally sensitive color developing layer, a precoating layer formed between a substrate and the thermally sensitive color developing layer, a protecting layer formed on the thermally sensitive color developing layer or an intermediate layer formed between the thermally sensitive color developing layer and the protecting layer. And the thermally sensitive recording medium of the present invention contains said hydrated silicic acid compound in at least one of these layers, especially, excellent effect can be accomplished by containing it in the thermally sensitive color developing layer. Further, thermally sensitive color developing layer, precoating layer, protecting layer or intermediate layer can be formed by single or by plural.

Since the hydrated silicic acid compound (silica) is a bulky pigment possessing specific features such as high oil absorbing capacity and excellent adiabatic ability, a technique to contain the hydrated silicic acid compound whose particle size, oil absorption amount and specific surface area are regulated in a thermally sensitive color developing layer, an undercoating layer or a protecting layer is disclosed. However, since particle size distribution of conventional hydrated silicic acid compound is broad, for example, although color developing sensitivity becomes good, new problems that coating layer strength and head abrasion resistance are deteriorated are arisen.

When a layer containing hydrated silicic acid compound A whose particle size distribution is broad with a layer containing hydrated silicic acid compound B whose particle size distribution is sharp are compared, wherein average particle size of silicate A and silicate B are equal, the strength of the coating layer containing hydrated silicic acid compound A is weaker than the strength of the coating layer containing hydrated silicic acid compound B, if the amount of a binder are same. The reason why is considered that the containing ratio of hydrated silicic acid compound of small particle size (specific surface area is large), which needs a binder, in hydrated silicic acid compound A is large. Therefore, by same amount of binder, strength of the layer containing hydrated silicic acid compound A becomes weak, accordingly, problems, for example, adhesion of stain to a blanket becomes easily arisen at offset printing process. It is possible to improve the strength of coating layer to the same level by increasing amount of binder in the coating layer containing hydrated silicic acid compound A, however, in this case, since containing ratio of hydrated silicic acid compound in the coating layer becomes law, problem of deterioration of color developing sensitivity is arisen. Further, in the case that hydrated silicic acid compound A and hydrated silicic acid compound B are contained in a thermally sensitive color developing layer or a protecting layer, which contacts with a thermal head, thermal head abrasion becomes worse when hydrated silicic acid compound A is contained. The reason why is considered as follows. That is, since many hydrated silicic acid compound of larger particle size is contained in hydrated silicic acid compound A, said large hydrated silicic acid compound particles make contact with the thermal head. However, by the reason mentioned below, desired quality can not be obtained by use of the conventional hydrated silicic acid compound.

In general, as the method for preparation of hydrated silicic acid compound, there are two methods, that is, one is the precipitation method that reacts sodium silicate with sulfuric acid by alkaline reaction and another one is the gelling method that reacts sodium silicate with sulfuric acid by acid reaction. In general, in these mentioned preparation methods, sodium silicate is completely neutralized by sulfuric acid and deposited coarse particles of hydrated silicic acid compound are dried, after that ground and classified and adjusted to the desired particle size. However, it is very difficult to control the particle size distribution. And it is considered that the deposited coarse particles of hydrated silicic acid compound are re-aggregated by drying process and form larger hydrated silicic acid compound particles. That is, when large particles and small particles are treated so as to be same particle size, in the case to grind large particles, there is possibility that finely ground particles and coarser ground particles are largely mixed together. And in the case when dried hydrated silicic acid compound are ground by a grinding machine such as bead mill, hydrated silicic acid compound particles are re-aggregated by heat of abrasion generated between hydrated silicic acid compound particles and beads, therefore, the particle size distribution of the obtained hydrated silicic acid compound particles becomes broad. Further, it is possible to make particle size distribution sharper by classifying the obtained ground particles, but it is not sufficient to meet the desired higher quality level.

On the contrary, the hydrated silicic acid compound used in the present invention is ground by wet grinding at the deposition process of hydrated silicic acid compound, specifically, during neutralization reaction process of sodium silicate, that is, prior hydrated silicic acid compound forms coarser particles, ground in wet condition so as to form desired particle size, therefore, the particle size distribution becomes sharp. It is desirable to carry out said neutralization reaction process and wet grinding process by dividing to several times, and it is possible to carry out wet grinding process before the neutralization reaction process is over and adjust to desired particle size. Further, by carrying out wet grinding, it is possible to prevent the generation of abrasion heat between hydrated silicic acid compound and beads, and more sharp particle size distribution can be obtained.

In the present invention, by using the hydrated silicic acid compound obtained as above, a thermally sensitive recording medium characterized to have strong coating layer strength and excellent printing aptitude can be obtained. Further, by using the hydrated silicic acid compound in a layer that contacts with a thermal head, a thermally sensitive recording medium characterized to have excellent head abrasion resistance too can be obtained.

Particle size distribution of the hydrated silicic acid compound contained in the thermally sensitive recording medium of the present invention is measured by laser lay method, and in particle size distribution by volume average particle size, it is desirable that the difference of particle size (D10/D90) between particle size which contains 10% integrated volume from the minimum size (D10) and contains 90% integrated volume from the minimum size (D90) is 9 μm or less, and the difference of particle size (D20/D80) between particle size which contains 20% integrated volume from the minimum size (D20) and contains 80% integrated volume from the minimum size (D80) is 5 μm or less, more desirably D10/D90 is 7 μm or less, and D20/D80 is 4 μm or less.

When D10/D90 is larger than 9 μm, the problems of deterioration of head abrasion resistance or deterioration of surface strength are arisen.

The average particle size of the hydrated silicic acid compound contained in the thermally sensitive recording medium of the present invention is desirable to be 1-15μm by laser lay method, more desirably 1-8μm, furthermore desirably is 1-4μm. When the average particle size is less than 1 μm, sufficient surface strength can not be obtained, and when the average particle size is larger than 15μm, head abrasion resistance becomes a problem.

The oil absorption amount of the hydrated silicic acid compound contained in the thermally sensitive recording medium of the present invention is 100-350ml/100 g, desirably is 130-350ml/100g. When the oil absorption amount is smaller than 100 ml/100 g, it is difficult to absorb fused color developing material by heat of a thermal head and causes the problem of adhering of debris to the thermal head, and when larger than 350 ml/100 g, surface strength deteriorates.

Further, in the present invention, the thermally sensitive recording medium that has good head debris resistance and excellent brightness, besides strong surface strength and head abrasion resistance can be obtained by using a hydrated silicate as a hydrated silicic acid compound. The reason why above mentioned excellent effect is obtained is not made clearly, but is guessed as follows.

That is, the hydrated silicate obtained by neutralization of aqueous solution of sodium silicate with mineral acid and aqueous solution of acidic metallic salt is a complex composed of hydrated silicic acid compound and metallic compound, and containing amount of the metallic compound is larger than that of conventional hydrated silicic acid compound obtained by a neutralization reaction of aqueous solution of sodium silicate with sulfuric acid, and this metallic compound promotes adsorption of a leuco dye, a color developing agent or a sensitizer, which are fused by heat of a thermal head, to the hydrated silicate, accordingly, high color developing sensitivity is displayed. Further, since superfluously fused color developing material is adsorbed too, debris adhesion to the thermal head is protected.

Furthermore, activity is weakened compared with a conventional hydrated silicic acid compound, because relative amount of hydroxide group that hydrated silicic acid compound has becomes small by containing metallic compound. Therefore, not only deterioration of brightness at the preparation of a coating is protected, but also brightness of a coating layer is improved, because refractive index of aluminum oxide is 1.65, while, that of silica is 1.48-1.49, namely, refractive index of metallic compound is relatively higher than that of silica.

In the present invention, it is desirable that the hydrated silicate contains 1.0-8.0 weight % of metallic compound (to SiO₂ weight %) by converted value to oxide, more desirably 1.0-6.0 weight %. If the content of the metallic compound is smaller than 1.0 weight %, the effect is not displayed sufficiently. While, if the content of the metallic compound is larger than 8.0 weight %, sufficient effect can not be obtained because the crystalline morphology is transferred.

In the thermally sensitive recording medium of the present invention, as the specific example of a metallic compound contained in the hydrated silicate, oxide of alkali earth metal such as magnesium oxide, calcium oxide, strontium oxide or barium oxide, titanium oxide, zirconium oxide, nickel oxide, iron oxide or aluminum oxide can be mentioned, however, not intending to be restricted to these compounds. Among these compounds, aluminum oxide is most desirable, from the view point of brightness and oil absorption amount.

The thermally sensitive recording medium of the present invention, can contain hydrated silicic acid compound, which is treated by wet grinding treatment in hydrated silicic acid compound deposition process, in at least one layer selected from the group consisting of an undercoating layer formed between a substrate and a thermally sensitive color developing layer, a protecting layer formed on a thermally sensitive color developing layer and an intermediate layer formed between a thermally sensitive color developing layer and a protecting layer for the purpose to improve color developing sensitivity. In the meanwhile, a thermally sensitive color developing layer, an undercoating layer, a protecting layer and an intermediate layer can be formed by single or by multiple.

The hydrated silicic acid compound used in the present invention is disclosed in JP2002-274837 A publication or JP 2908253 publication, and can be prepared as follows. That is, mineral acid (sulfuric acid) is added by dividing to several times to an aqueous solution of sodium silicate and treated by wet grinding treatment in hydrated silicic acid compound deposition process so as to be the desired average particle size. Further, in the preparation process of hydrated silicate used in the present invention, it is desirable to carry out a neutralizing reaction by dividing to several processes, however, if the numbers of the neutralizing process become excessive, the production effect is deteriorated, therefore, it is desirable to divide the neutralizing reaction to 3 processes around.

As disclosed in JP 2908253 publication, the hydrated silicic acid compound used in the present invention can be ground in wet condition by a ball mill which is called in a broad sense, such as ball mill or rod mill, a medium stirring grinding machine such as tower mill, attriter, satory mill, sand grinder or annular miller or a high speed rotating grinding machine such as colloid mill, homo mixer or inline mill, and desirably the grinding condition can be voluntarily adjusted. And the particles of deposited silica or silicate are very fine, especially, since the silica deposited in the first process is easy to be ground, it can be ground by a dispersing machine or an emulsifying machine besides above mentioned grinding machine, it is possible to use these machines by combining.

The hydrated silicate used in the thermally sensitive recording medium of the present invention can be obtained by replacing a part of mineral acid (sulfuric acid) by aqueous solution of acidic metallic salt in above mentioned method for preparation of hydrated silicic acid compound. As a metal element composing the aqueous solution of acidic metallic salt, for example, alkali earth metal element such as magnesium, calcium, strontium or barium or titanium, zirconium, nickel iron or aluminum and as aqueous solution of acidic metallic salt, acidic metallic sulfate can be mentioned, and is not restricted, however, it is desirable to use aluminum sulfate.

The hydrated silicate used in the thermally sensitive recording medium of the present invention whose content of metallic compound is 0.5-8.0 weight % (to SiO₂ weight %, measured by fluorescent X-ray analyzer Oxford ED2000) by converted value to oxide can be obtained by using aqueous solution of acidic metallic salt corresponding to 5-60 weight % to neutralization equivalent of sodium silicate in stead of mineral acid (sulfuric acid) in at least one process at the adding process of acid in above mentioned method for preparation of hydrated silicic acid compound. Oil absorption amount of the hydrated silicate becomes almost equal level to that of hydrated silicic acid compound which is prepared without adding aqueous solution of acidic metal, further the advantage that the specific scattering coefficient becomes high can be also accomplished by silication.

In the thermally sensitive recording medium, content of hydrated silicate is desirable to be within following range to each layer. That is, 10-60 weight %, desirably 20-50 weight % in a thermally sensitive color developing layer, 20-80 weight %, desirably 30-70 weight % in an undercoating layer, 10-80 weight %, desirably 20-70 weight % in a protecting layer.

As an electron donating leuco dye used in the present invention, any kinds of dye which are public known in fields of pressure sensitive or thermally sensitive recording medium can be used and not restricted, and for example, triphenylmethane compounds, fluorane compounds, fluorene or divinyl compounds are desirably used. Examples of specific colorless or pale colored dye (dye precursor) are shown as follows. These dye precursors can be used alone or together with.

<Triphenyl Methane Leuco Dye>

3,3′-bis(p-dimethylaminophenyl)-6-dimethylaminophthalide [another name; Crystal Violet Lacton],
3,3-bis(p-dimethylaminophenyl)phthalide [another name is Malachite Green Lactone]
   <Fluorane Leuco Dyes>
3-diethylamino-6-methylfluorane
3-diethylamino-6-methyl-7-anilinofluorane
3-diethylamino-6-methyl-7-(o,p-dimethylanilino)fluorane
3-diethylamino-6-methyl-7-chlorofluorane
3-diethylamino-6-methyl-7-(m-trifluoromethylanilino)fluorane
3-diethylamino-6-methyl-7-(o-chloroanilino)fluorane
3-diethylamino-6-methyl-7-(p-chloroanilino)fluorane
3-diethylamino-6-methyl-7-(o-fluoroanilino)fluorane
3-diethylamino-6-methyl-7-(m-methylanilino)fluorane
3-diethylamino-6-methyl-7-n-octylanilinofluorane
3-diethylamino-6-methyl-7-n-octylaminofluorane
3-diethylamino-6-methyl-7-benzylaminofluorane
3-diethylamino-6-methyl-7-dibenzylamonofluorane
3-diethylamino-6-chloro-7-methylfluorane
3-diethylamino-6-chloro-7-anilinofluorane
3-diethylamino-6-chloro-7-p-methylanilinofluorane
3-diethylamino-6-ethoxyethyl-7-anilinofluorane
3-diethylamino-7-methylfluorane
3-diethylamino-7-chlorofluorane
3-diethylamino-7-(m-trifluoromethylanilino)fluorane
3-diethylamino-7-(o-chloroanilino)fluorane
3-diethylamino-7-(p-chloroanilino)fluorane
3-diethylamino-7-(o-fluoroanilino)fluorane
3-diethylamino-benzo[a]fluorane
3-diethylamino-benzo[c]fluorane
3-dibutylamino-6-methyl-fluorane
3-dibutylamino-6-methyl-7-anilinofluorane
3-dibutylamino-6-methyl-7-(o,p-dimethylanilino)fluorane
3-dibutylamino-6-methyl-7-(o-chloroanilino)fluorane
3-dibutylamino-6-methyl-7-(p-chloroanilino)fluorane
3-dibutylamino-6-methyl-7-(o-fluoroanilino)fluorane
3-dibutylamino-6-methyl-7-(m-trifluoromethylanilino)fluorane
3-dibutylamino-6-methyl-chlorofluorane
3-dibutylamino-6-ethoxyethyl-7-anilinofluorane
3-dibutylamino-6-chloro-7-anilinofluorane
3-dibutylamino-6-methyl-7-p-methylanilinofluorane
3-dibutylamino-7-(o-chloroanilino)fluorane
3-dibutylamino-7-(o-fluoroanilino)fluorane
3-di-n-pentylamino-6-methyl-7-anilinofluorane
3-di-n-pentylamino-6-methyl-7-(p-chloroanilino)fluorane
3-di-n-pentylamino-7-(m-trifluoromethylaniliono)fluorane
3-di-n-pentylamino-6-chloro-7-anilinofluorane
3-di-n-pentylamino-7-(p-chloroanilino)fluorane
3-pyrrolidino-6-methyl-7-anilinofluorane
3-piperidino-6-methyl-7-anilinofluorane
3-(N-methyl-N-propylamino)-6-methyl-7-anilinofluorane
3-(N-methyl-N-cyclohexylamino)-6-methyl-7-anilinofluorane
3-(N-ethyl-N-cyclohexylamino)-6-methyl-7-anilinofluorane
3-(N-ethyl-N-xylamino)-6-methyl-7-(p-chloroanilino)fluorane
3-(N-ethyl-p-toluidino)-6-methyl-7-anilinofluorane
3-(N-ethyl-N-isoamylamino)-6-methyl-7-anilinofluorane
3-(N-ethyl-N-isoamylamino)-6-chloro-7-anilinofluorane
3-(N-ethyl-N-tetrahydrofurfurylamino) -6-methyl-7 -anilinofluorane
3-(N-ethyl-N-isobutylamino)-6-methyl-7-anilinofluorane
3-(N-ethyl-N-ethoxypropylamino)-6-methyl-7-anilinofluorane
3-cyclohexylamino-6-chlorofluorane
2-(4-oxahexyl)-3-dimethylamino-6-methyl-7-anilinofluorane
2-(4-oxahexyl)-3-diethylamino-6-methyl-7-anilinofluorane
2-(4-oxahexyl)-3-dipropylamino-6-methyl-7-anilinofluorane
2-methyl-6-p-(p-dimethylaminophenyl)aminoanilinofluorane
2-methoxy-6-p-(p-dimethylaminophenyl)aminoanilinofluorane
2-chloro-3-methyl-6-p-(p-phenylaminophenyl)aminoanilinofluorane
2-chloro-6-p-(p-dimethylaminophenyl)aminoanilinofluorane
2-nitro-6-p-(p-diethylaminophenyl)aminoanilinofluorane
2-amino-6-p-(p-diethylaminophenyl)aminoanilinofluorane
2-diethylamino-6-p-(p-diethylaminophenyl)aminoanilinofluorane
2-phenyl-6-methyl-6-p-(p-phenylaminophenyl)aminoanilinofluorane
2-benzyl-6-p-(p-phenylaminophenyl)aminoanilinofluorane
2-hydroxy-6-p-(p-phenylaminophenyl)aminoanilinofluorane
3-methyl-6-p-(p-dimethylaminophenyl)aminoanilinofluorane
3-diethylamino-6-p-(p-diethylaminophenyl)aminoanilinofluorane
3-diethylamino-6-p-(p-dibutylaminophenyl)aminoanilinofluorane
2,4-dimethyl-6-[(4-dimethylamino)anilino]-fluorane
   <Fluorene Leuco Dyes>
3,6,6′-tris(dimethylamino)spiro[fluorene-9,3′-phthalide]
3,6,6′-tris(diethylamino)spiro[fluorene-9,3′-phthalide]
   <Divinyl Leuco Dyes>
3,3-bis-[2-(p-dimethylaminophenyl)-2-(p-methoxyphenyl)ethenyl]-4,5,6,7-te trabromo phthalide
3,3-bis-[2-(p-dimethylaminophenyl)-2-(p-methoxyphenyl)ethenyl]-4,5,6,7-te trachloro phthalide
3,3-bis-[1,1-bis(4-pyrrolidinophenyl)ethylene-2-yl]-4,5,6,7-tetrabromophthal ide
3,3-bis-[1-(4-methoxyphenyl)-1-(4-pyrrolidinophenyl)ethylene-2-yl]-4,5,6,7-t etra chlorophthalide
   <Others>
3-(4-diethylamino-2-ethoxyphenyl)-3-(1-ethyl-2-methylindol-3-yl)-4-azaphth alide
3-(4-diethylamino-2-ethoxyphenyl)-3-(1 -octyl-2-methylindol-3 -yl)-4-azaphth alide
3-(4-cyclohexylethylamino-2-methoxyphenyl)-3-(1 -ethyl-2-methylindol-3-yl) -4-azaphthalide
3,3-bis(l-ethyl-2-methylindol-3-yl)phthalide
3,6-bis(diethylamino)fluorane-y-(3′-nitro)anilinolactam
3,6-bis(diethylamino)fluorane-7-(4′-nitro)anilinolactam
1,1-bis-[2′,2′,2″,2″-tetrakis-(p-dimethylaminophenyl)-ethenyl]-2,2-dinitrilet hane
1,1-bis-[2′,2′,2″,2″-tetrakis-(p-dimethylaminophenyl)-ethenyl]-2-1A -naphtho yl ethane
1,1-bis-[2′,2′,2″,2″-tetrakis-(p-dimethylaminophenyl)-ethenyl]-2,2-diacetylet hane
bis-[2,2,2′,2′-tetrakis-(p-dimethylaminophenyl)-ethenyl]-methylmalonic acid dimethyl ester.

In the present invention, conventional public known color developing agent can be used in the range not obstructing desired effect to previously mentioned object. As an example of the color developing agent, activated clay, attapulgite, bisphenol A, 4-hydroxybenzoates, 4-hydroxydiphthalates, phthalic acid monoesters, bis-(hydroxyphenyl)sulfides, 4-hydroxyphenylarylsulfones, 4-hydroxyphenylarylsulfonates, 1,3-di[2-(hydroxyphenyl)-2-propyl]-benzenes, 4-hydroxybenzoyloxybenzoate, bisphenolsulfones, aminobenzenesulfonamide compound disclosed in JP H8-59603 A publication, diphenylsulfone crosslinked compounds disclosed in WO97/16420 International Publication, phenolic compound disclosed in WO02/081229 International Publication or JP2002-301873 A publication, phenylnovolac condensation compounds disclosed in WO02/0987674 International Publication or WO03/029017 International Publication, urea-urethane compounds disclosed in WO00/14058 International Publication or JP2000-143611 A publication or thiourea compounds such as N,N′-di-m-chlorophenylthiourea can be mentioned. These compounds can be used alone or together with. Among these compounds, 4,4′-dihydroxy diphenylsulfone (bisphenol S) and 4-hydroxy-4′-isopropoxydiphenylsulfone are most desirable from the view point of developed color tone and preservability.

Further, in the present invention, conventional well-known sensitizer can be used. As the specific example of the sensitizer, saturated fatty acid mono amide, ethylenebisfattyacid amide, montan wax, polyethylene wax, 1,2-di(3-methylphenoxy)ethane, p-benzylbiphenyl, 4-biphenyl-p-tolylether, m-terphenyl, 1,2-diphenoxyethane, 4,4′-ethylenedioxy-bis-dibenzyl benzoate, dibenzoiloxymethane, 1,2-diphenoxyethane, bis[2-(4-methoxy-phenoxy)ethyl]ether, p-methylnitrobenzoate, benzyl p-benzyloxybenzoate, di-p-tolylcabonate, phenyl-α-naphthylcarbonate, 1,4-diethoxynaphthalene, 1-hydroxy-2-naphthoate, 4-(m-methylphenoxymethyl)diphenyl, dimethylphthalate, naphthylbenzylether, di-(p-methylbenzyl)oxalate, di-(p-chlorobenzyl)oxalate and 4-acethylbiphenyl can be mentioned, however, not intending to be limited to these compounds.

As a binder to be used in the present invention, for example, completely saponified polyvinyl alcohol having a degree of polymerization of 200 to 1,900, partially saponified polyvinyl alcohol, carboxy denatured polyvinyl alcohol, amide denatured polyvinyl alcohol, sulfonic acid denatured polyvinyl alcohol, butyral denatured polyvinyl alcohol, other denatured polyvinyl alcohol, hydroxyethylcellulose, methylcellulose, carboxymethylcellulose, styrene-maleic anhydride copolymer, styrene-butadiene copolymer, cellulose derivative such as ethylcellulose or acetylcellulose, polyvinyl chloride, polyvinyl acetate, polyacrylamide, polyacrylate, polyvinyl butyral, polystyrol and a copolymer thereof, polyamide resin, silicon resin, petroleum resin, terpene resin, ketone resin and cumarone resin can be mentioned. Those high molecular weight substances can be used by dissolving in a solvent such as water, alcohol, ketones, esters or hydrocarbon, or emulsifying or dispersing as a paste in water or another medium, and can be used according to the desired quality.

Further, in the present invention, as an image stabilizer, which displays oil resistance effect, in the range not obstructing the desired effect to the previously mentioned object,
4,4′-buthylidene (6-t-butyl-3-methylphenol),
2,2′-di-t-butyl-5,5′-dimethyl-4,4′-sulphonyldiphenol,
1,1,3-tris(2-methyl-4-hydroxy-5-cyclohexylphenyl)butane or
1,1,3-tris(2-methyl-4-hydroxy-5-t-butylphenyl)butane or others can be added.

In the present invention, organic or inorganic fillers such as different kind of silica, calcium carbonate, kaolin, calcined kaoline, diatomaceous earth, talk, titanium oxide or aluminum can be used together with in the range not obstructing the effect besides above mentioned hydrated silicate of the present invention.

Further, it is possible to use a slipping agent such as waxes, U.V. ray absorbing agent such as benzophenons or triazols, water resistance agent such as glyoxal, dispersing agent, defoaming agent, anti oxidant agent or fluorescent dye can be used.

The kinds and amount of color developing agent, dye and other components which are used in the thermally sensitive recording medium of the present invention, are decided according to the required properties and recording aptitude and not restricted, however, in general, 0.1 to 2 parts of basic colorless dye and 0.5 to 4 parts of filler are used to 1 part of color developing agent, and the desirable amount of binder is 5-25% in total solid amount.

By applying a coating liquid of above mentioned composition on a substrate such as paper, recycled paper, synthetic paper, film, plastic film, plastic foam film or non-woven cloth, desired thermally sensitive recording sheet can be obtained. Further, complex sheet prepared by combining these sheets can be also used as a substrate.

Above mentioned organic color developing agent, basic colorless dye and additives to be added according to necessity are ground by a grinding machine such as ball mill, attreiter or sand grinder or adequate emulsifying machine so as the particle size to become several micron or less, further, a binder and various additives are added according to the object, and a coating liquid is prepared. Method for coating is not restricted, and conventional well-known techniques can be used, for example, an off machine coater with various coaters such as air knife coater, rod blade coater, bill blade coater, roll coater or curtain coater or an on machine coater can be voluntarily chosen and used.

### EXAMPLE

The present invention will be illustrated more actually according to the Examples. And, in the illustration, the term of part indicated weight parts.

### PREPARATION EXAMPLE 1

(1) First process (neutralization ratio; 40%); 3rd grade sodium silicate on the market (SiO₂:20.0 weight %, Na₂O:9.5 weight %) is diluted by water in a reaction vessel (200 liter volume), and 200 liter of diluted sodium silicate solution of 6.7 weight % as SiO₂ is prepared. This sodium silicate solution is heated to 85° C., then aluminum sulfate (8 weight % concentration as Al₂O₃; hereinafter shortened to band) of corresponding amount to 10 weight % of neutralizing equivalent is added by 200g/min dropping speed by strong stirring condition not to grow coarse gel, then sulfuric acid (concentration; 98 weight %) of corresponding amount to 30 weight % of neutralizing equivalent. After added, obtained partially neutralized solution is matured under continuous stirring, and simultaneously treated by cyclic grinding (aiming 7 μm particle size) by a vertical sand grinder (volume 2 gallons, filling ratio of 1 mm diameter glass beads is 70 weight %). This maturing and grinding treatments are carried out for 3 hours.
(2) Second process (neutralization ratio; 40%); Then, temperature of slurry is elevated to 90° C., and sulfuric acid of same concentration as the first process is added by same condition as the first process to 80 weight % of neutralizing equivalent and is matured under continuous stirring for 32 minutes.
(3) Third process (neutralization ratio; 20%); After that, sulfuric acid of same concentration is added to the matured slurry by 76 g/min dropping speed and pH of slurry is adjusted to 6.
(4) Evaluation; Slurry after third process is filtrated, washed by water and re-pulped to DI water, then hydrated silicic acid slurry is recovered. Average particle size of the obtained slurry is measured. Further, the slurry is filtrated and dissolved in ethanol so as the solid part to be 10 weight % and filtrated again. Then dried at 105° C. and oil absorption amount is measured. Average particle size of the obtained particles is 6.1 μm and oil absorption amount is 230 ml/100 g. Other features are shown in Table 1.

### PREPARATION EXAMPLE 2

By same method to the Preparation Example 1, except changing adding amount of aluminum sulfate in the first process to 20 weight %, hydrated silicate is prepared. The features of the obtained hydrated silicate are shown in Table 1.

### PREPARATION EXAMPLE 3

By same method to the Preparation Example 1, except changing adding amount of aluminum sulfate in the first process to 40 weight % (total amount), hydrated silicate is prepared. The features of the obtained hydrated silicate are shown in Table 1.

### PREPARATION EXAMPLE 4

By same method to the Preparation Example 1, except changing adding amount of aluminum sulfate in the first process to 40 weight % (total amount) and changing the adding amount of aluminum sulfate in the second process to 20% of neutralization equivalent, hydrated silicate is prepared. The features of the obtained hydrated silicate are shown in Table 1.

### PREPARATION EXAMPLE 5-6

The hydrated silicate obtained in Preparation Example 2 is ground in wet condition and two kinds of hydrated silicate whose particle size are different are prepared. The features of the obtained hydrated silicate are shown in Table 1.

### PREPARATION EXAMPLE 7-8

By same method to the Preparation Example 1, except not using band in the first, second and third processes and using sulfuric acid for all 100 weight % of neutralization equivalent, and changing grinding condition in the first process, two kinds of hydrated silicate are prepared. The features of the obtained hydrated silicate are shown in Table 1.

### PREPARATION EXAMPLE 9-10

The hydrated silicate obtained in Preparation Example 8 is ground in wet condition and two kinds of hydrated silicate whose particle size are different are prepared. The features of the obtained hydrated silicate are shown in Table 1.

### PREPARATION EXAMPLE 11

The hydrated silicate obtained in Preparation Example 2 is dried then ground in a ball mill and two kinds of hydrated silicate whose particle size are different are prepared. The features of the obtained hydrated silicate are shown in Table 1.

### PREPARATION EXAMPLE 12

The hydrated silicate obtained in Preparation Example 7 is dried then ground in a ball mill and two kinds of hydrated silicate whose particle size are different are prepared. The features of the obtained hydrated silicate are shown in Table 1

Oil absorption amount, particle size distribution and content of metallic compound (aluminum) of the hydrated silicate obtained by the preparation Examples 1-12 are measured as follows.
Oil absorption amount: measured by the method prescribed in JIS-K-5101
Particle size distribution (laser diffraction/scattering method): specimen of slurry of hydrated silicate is dropped and mixed in DI water to which 0.2 weight % of sodium hexametaphosphate, which is a dispersing agent, is added and uniform dispersion is obtained, and measured by a laser type particle size measuring machine (used instrument: Mastersizer S type, product of Malvern).

Content of aluminum: measured by a fluorescent X-ray analyzer (used instrument: Oxford ED 2000 type).

TABLE 1

| | | ave. | oil | | particle size | | |
|---|---|---|---|---|---|---|---|
| | amount | particle | absorption | content | distribution | | |
| hydrated silicate | of alminium | size | amount | of | D10/ | D20/ | |
| Prep. Example | sulfate | μm | ml/100 g | Al₂O₃ % | D90 | D80 | remarks |
| 1 | 10% | 6.1 | 230 | 1.1 | 8.5 | 4.2 | |
| 2 | 20% | 5.1 | 257 | 2.5 | 7.3 | 3.5 | |
| 3 | 40% | 5.5 | 214 | 5.0 | 7.9 | 4.4 | |
| 4 | 60% | 4.6 | 201 | 6.6 | 8.7 | 3.8 | |
| 5 | 20% | 2.3 | 155 | 2.5 | 6.1 | 3.9 | *1 |
| 6 | 20% | 1.4 | 119 | 2.5 | 4.8 | 2.6 | |
| 7 | 0% | 5.4 | 313 | 0.0 | 8.9 | 4.5 | |
| 8 | 0% | 4.1 | 301 | 0.0 | 8.1 | 4.1 | |
| 9 | 0% | 3.3 | 235 | 0.0 | 7.8 | 3.8 | *2 |
| 10 | 0% | 2.2 | 177 | 0.0 | 6.3 | 3.6 | |
| 11 | 20% | 2.5 | 151 | 2.5 | 14.3 | 10.6 | *3 |
| 12 | 0% | 2.7 | 156 | 0.0 | 13.2 | 10.8 | *4 |
| silica on | — | 3.7 | 240 | 0.7 | 15.4 | 10.3 | X37B |
| the | — | 1.7 | 110 | 0.0 | 16.2 | 11.5 | P604 |
| market | — | 3.3 | 250 | 0.0 | 13.3 | 9.8 | P78A |

Particle size distribution
D10/D90: difference between D10 and D90 (μm)
D20/D80: difference between D20 and D80 (μm)
*1: grinding of Preparation Example 2
*2: grinding of Preparation Example 8
*3: dry grinding of Preparation Example 2
*4: dry grinding of Preparation Example 7

### EXAMPLES·COMPARATIVE EXAMPLES

### EXAMPLE 1

<Coating Liquid for Undercoat Layer>

| | |
|---|---|
| hydrated silicate of preparation Example 2 (solid part 20%) | 250.0 parts |
| 10% aqueous solution of 10% polyvinyl alcohol | 50.0 parts |

Coating liquid for under layer of above blending ratio is prepared.

<Coating Liquid for Thermally Sensitive Layer>

Regarding each materials for dye, color developing agent, dispersions of following blending ratio are previously prepared, and are separately ground in wet condition by a sand grinder so as the average particle size to be 0.5 μm.

<Dispersion of Color Developing Agent>

| | |
|---|---|
| 4-hydroxy-4′-isopropoxydiphenylsulfone | 6.0 parts |
| 10% aqueous solution of polyvinyl alcohol | 18.8 parts |
| water | 11.2 parts |

<Dispersion of Dye>

| | |
|---|---|
| 3-di-n-butylamino-6-methyl-7-anionofluorane (ODB-2) | 3.0 parts |
| 10% aqueous solution of polyvinyl alcohol | 6.9 parts |
| water | 3.9 parts |

<Dispersion of Sensitizer >

| | |
|---|---|
| diphenylsulfone | 6.0 parts |
| 10% aqueous solution of polyvinyl alcohol | 18.8 parts |
| water | 11.2 parts |

Compositions mentioned below are mixed and the coating liquid for thermally sensitive color developing layer is obtained.

| | |
|---|---|
| dispersion of color developing agen | 36.0 parts |
| dispersion of dye (ODB-2) | 13.8 parts |
| dispersion of sensitizer | 36.0 parts |
| 30% dispersion of kaolin (CAPIM CC, product of RIO | 43.0 parts |
| CAPIM) | |
| 30% dispersion of zinc stearate | 6.7 parts |

<thermally sensitive recording medium>

Above mentioned coating liquid for an undercoat layer is coated on the surface of a paper whose grammage is 50 g/m² and dried so as the dry weight to be 6.0 g/m² and treated by a super calendar so as the Beck smoothness to be 600-800 seconds then a thermally sensitive recording medium is obtained.

### EXAMPLE 2

<Coating Liquid for Under Layer>

| | |
|---|---|
| 30% dispersion of kaolin (CAPIM CC, product of RIO | 167.0 parts |
| CAPIM) | |
| 10% aqueous solution of polyvinyl alcohol | 50.0 parts |

Coating liquid for under layer of above blending ratio is prepared.

<Coating Liquid for Thermally Sensitive Layer>

By same process to Example 1 except changing kaolin dispersion to 65 parts of hydrated silicate (solid part 20%) of Preparation Example 2, a coating liquid for a thermally sensitive layer is obtained.

<Thermally Sensitive Recording Medium>

A thermally sensitive recording medium is obtained by same process to Example 1 using above mentioned coating liquid for under layer and for thermally sensitive layer.

### EXAMPLE 3

By same process to Example 1, except changing the hydrated silicate of Preparation Example 2 to the hydrated silicate of Preparation Example 5 (solid part 20%), a thermally sensitive recording medium is prepared.

### EXAMPLE 4

By same process to Example 2, except changing the hydrated silicate of Preparation Example 2 to the.hydrated silicate of Preparation Example 5 (solid part 20%), a thermally sensitive recording medium is prepared.

### EXAMPLE 5

By same process to Example 1, except changing kaolin dispersion to the hydrated silicate of Preparation Example 5 (solid part 20%), a thermally sensitive recording medium is prepared.

### EXAMPLE 6

By same process to Example 1, except changing the hydrated silicate of Preparation Example 2 to the hydrated silicate of Preparation Example 1 (solid part 20%), a thermally sensitive recording medium is prepared.

### EXAMPLE 7

By same process to Example 1, except changing the hydrated silicate of Preparation Example 2 to the hydrated silicate of Preparation Example 3 (solid part 20%), a thermally sensitive recording medium is prepared.

### EXAMPLE 8

By same process to Example 1, except changing the hydrated silicate of Preparation Example 2 to the hydrated silicate of Preparation Example 4 (solid part 20%), a thermally sensitive recording medium is prepared.

### EXAMPLE 9

By same process to Example 2, except changing the hydrated silicate of Preparation Example 2 to the hydrated silicate of Preparation Example 1 (solid part 20%), a thermally sensitive recording medium is prepared.

### EXAMPLE 10

By same process to Example 2, except changing the hydrated silicate of Preparation Example 2 to the hydrated silicate of Preparation Example 3 (solid part 20%), a thermally sensitive recording medium is prepared.

### EXAMPLE 11

By same process to Example 2, except changing the hydrated silicate of Preparation Example 2 to the hydrated silicate of Preparation Example 4 (solid part 20%), a thermally sensitive recording medium is prepared.

### EXAMPLE 12

By same process to Example 1, except changing the hydrated silicate of Preparation Example 2 to the hydrated silicate of Preparation Example 9 (solid part 20%), a thermally sensitive recording medium is prepared.

### EXAMPLE 13

By same process to Example 2, except changing the hydrated silicate of Preparation Example 2 to the hydrated silicate of Preparation Example 9 (solid part 20%), a thermally sensitive recording medium is prepared.

### COMPARATIVE EXAMPLE 1

By same process to Example 1, except changing the hydrated silicate of Preparation Example 2 to the hydrated silicate of Preparation Example 11 (solid part 20%), a thermally sensitive recording medium is prepared.

### COMPARATIVE EXAMPLE 2

By same process to Example 1, except changing the hydrated silicate of Preparation Example 2 to the hydrated silicate of Preparation Example 12 (solid part 20%), a thermally sensitive recording medium is prepared.

### COMPARATIVE EXAMPLE 3

By same process to Example 2, except changing the hydrated silicate of Preparation Example 2 to the hydrated silicate of Preparation Example 11 (solid part 20%), a thermally sensitive recording medium is prepared.

### COMPARATIVE EXAMPLE 4

By same process to Example 2, except changing the hydrated silicate of Preparation Example 2 to the hydrated silicate of Preparation Example 12 (solid part 20%), a thermally sensitive recording medium is prepared.

### COMPARATIVE EXAMPLE 5

By same process to Example 5, except changing the hydrated silicate of Preparation Example 5 to the hydrated silicate of Preparation Example 11 (solid part 20%), a thermally sensitive recording medium is prepared.

### COMPARATIVE EXAMPLE 6

By same process to Example 1, except changing the hydrated silicate of Preparation Example 2 to silica on the market, a thermally sensitive recording medium is prepared.

### REFERENCE EXAMPLES 1-3

By same process to Example 1, except changing the hydrated silicate of Preparation Example 2 to silica on the market<X37B(product of Tokuyama), P604(product of Mizusawa Kagaku), P78A(product of Mizusawa Kagaku): solid part 20%>, a thermally sensitive recording media are prepared.

### REFERENCE EXAMPLES 4-6

By same process to Example 2, except changing the hydrated silicate of Preparation Example 2 to silica on the market <X37B(product of Tokuyama), P604(product of Mizusawa Kagaku), P78A(product of Mizusawa Kagaku): solid part 20%>, a thermally sensitive recording media are prepared.

Evaluation tests of following evaluation items are carried out on specimens obtained by above mentioned Examples, Comparative Examples and Reference Examples. Results are shown in Table 2.

(Color Developing Sensitivity)

Printing test is carried out on the prepared thermally sensitive recording medium at an applied energy of 0.34 mJ/dot by using TH-PMD, which is the product of Okura Denki. Density of the printed image is measured by a Macbeth Densitometer (using an amber filter).

(Head Debris)

Printing test is carried out by using Label Printer L'esprit T8, which is product of Sato, and adhesion of head debris is evaluated by inspector's eye.
◯: head debris is not observed
Δ: head debris is observed slightly, come off of printing is not observed
X: many head debris are observed, come off of printing is observed
   (stick)

Printing test is carried out by using Canon Handy Terminal HT180 at 0° C. and presence of stick is confirmed.
◯: white come off at full printed part is not observed
Δ: white come off at full printed part is slightly observed
X: many white come offs at full printed part head debris are observed
   (Brightness)

JIS P8123

(Printing Aptitude (Surface Strength))

Presence of surface picks is measured by inspector's eye when printing ink (Tack 9) is printed on the surface of thermally sensitive recording medium by 100 m/min Using Prufbau printer, and evaluated according to following standard.
◯: surface picks are not observed
Δ: surface picks are slightly observed
X: many surface picks are observed
   (Abrasion of Head)

Abrasion of a head by prepared thermally sensitive recording media is measured by a thermal printer LTP-411, which is a product of Seiko Electric Industries. 720,000 lines printing test is carried out by following conditions;

applying electric voltage: 5.1V,

method for printing: go and back printing,

printing pattern: black part 50% printing,

evaluation standard is as follows.

◯: good printing is available without causing head worn out

X: head worn out is caused and come off of printing is observed

TABLE 2

| | | | | | printing | | | | |
|---|---|---|---|---|---|---|---|---|---|
| | | | thermally | color | aptitude | debris | | head | |
| | | undercoat | sensitive | developing | (coating layer | adhering | sticking | abrasion | |
| | | layer | recording layer | sensitivity | strength) | resistance | resistance | resistance | brightness % |
| Example | 1 | Prep. Ex. 2 | kaolin | 1.43 | ◯ | ◯ | ◯ | — | 89 |
| | 2 | kaolin | Prep. Ex. 2 | 1.50 | ◯ | ◯ | ◯ | ◯ | 89 |
| | 3 | Prep. Ex. 5 | kaolin | 1.49 | ◯ | ◯ | ◯ | — | 89 |
| | 4 | kaolin | Prep. Ex. 5 | 1.50 | ◯ | ◯ | ◯ | ◯ | 90 |
| | 5 | Prep. Ex. 2 | Prep. Ex. 5 | 1.52 | ◯-Δ | ⊚ | ⊚ | ◯ | 90 |
| | 6 | Prep. Ex. 1 | kaolin | 1.44 | ◯ | ◯-Δ | ◯-Δ | — | 89 |
| | 7 | Prep. Ex. 3 | kaolin | 1.45 | ◯ | ◯ | ◯ | — | 89 |
| | 8 | Prep. Ex. 4 | kaolin | 1.43 | ◯ | Δ | Δ | — | 89 |
| | 9 | kaolin | Prep. Ex. 1 | 1.47 | ◯ | ◯ | ◯ | ◯ | 89 |
| | 10 | kaolin | Prep. Ex. 3 | 1.48 | ◯ | ◯ | ◯ | ◯ | 89 |
| | 11 | kaolin | Prep. Ex. 4 | 1.46 | ◯ | Δ | Δ | ◯ | 89 |
| | 12 | Prep. Ex. 9 | kaolin | 1.42 | ◯ | X | X | — | 86 |
| | 13 | kaolin | Prep. Ex. 9 | 1.37 | ◯ | X | X | ◯ | 86 |
| Comparative | 1 | Prep. Ex. 11 | kaolin | 1.40 | X | ◯ | ◯ | — | 84 |
| Example | 2 | Prep. Ex. 12 | kaolin | 1.43 | X | ◯ | ◯ | — | 85 |
| | 3 | kaolin | Prep. Ex. 11 | 1.43 | X | ◯ | ◯ | X | 89 |
| | 4 | kaolin | Prep. Ex. 12 | 1.45 | X | ◯ | ◯ | X | 85 |
| | 5 | Prep. Ex. 11 | Prep. Ex. 11 | 1.43 | X | ⊚ | ⊚ | X | 90 |
| | 6 | kaolin | kaolin | 1.29 | ◯ | X | X | ◯ | 83 |
| Reference | 1 | X37B | kaolin | 1.45 | X | — | — | — | 85 |
| Example | 2 | P604 | kaolin | 1.49 | X | — | — | — | 86 |
| | 3 | P78A | kaolin | 1.47 | X | — | — | — | 85 |
| | 4 | kaolin | X37B | 1.48 | X | — | — | X | 86 |
| | 5 | kaolin | P604 | 1.46 | X | — | — | X | 87 |
| | 6 | kaolin | P78A | 1.47 | X | — | — | X | 87 |

### INDUSTRIAL APPLICABILITY

By the present invention, a thermally sensitive recording medium having excellent color developing sensitivity and strong coating layer strength can be obtained by a thermally sensitive recording medium comprising, single or multi layers, wherein, at least one layer on a substrate is a thermally sensitive recording layer that contains a colorless or pale colored electron donating leuco dye and an electron accepting color developing agent, further, at least one layer on the substrate contains hydrated silicic acid compound which is treated by wet grinding treatment in deposition process of the hydrated silicic acid compound. Especially, when the hydrated silicic acid compound is hydrated silicate, a thermally sensitive recording medium of high brightness, which is superior in color developing sensitivity and coating layer strength, further excellent in head abrasion resistance, debris adhering resistance and sticking resistance can be obtained. Further, by containing the hydrated silicic acid compound in a layer which contacts with a thermal head, head abrasion resistance is improved.

1. A thermally sensitive recording medium comprising, single or multi layers, wherein, at least one layer on a substrate is a thermally sensitive recording layer that contains a colorless or pale colored electron donating leuco dye and an electron accepting color developing agent, further, at least one layer on the substrate contains hydrated silicic acid compound which is treated by wet grinding treatment in deposition process of the hydrated silicic acid compound.

2. The thermally sensitive recording medium of claim 1, wherein the hydrated silicic acid compound is hydrated silicate obtained by neutralization of aqueous solution of sodium silicate with mineral acid and aqueous solution of acidic metallic salt.

3. The thermally sensitive recording medium of claim 2, wherein the content of metallic compound in the hydrated silicate to SiO₂ weight % by converted value to oxide is 1.0-8.0 weight %.

4. The thermally sensitive recording medium of claim 1, wherein the difference of particle size (D10/D90) between particle size which contains 10% integrated volume from the minimum size (D10) and contains 90% integrated volume from the minimum size (D90) is 9 μm or less, and the difference of particle size (D20/D80) between particle size which contains 20% integrated volume from the minimum size (D20) and contains 80% integrated volume from the minimum size (D80) is 5 μm or less, more desirably D10 /D90 is 7 μm or less, and D20/D80 is 4 μm or less.

5. The thermally sensitive recording medium according to claim 1, wherein average particle size of the hydrated silicic acid compound is 1-15 μm measured by laser lay method and oil absorption amount is 100-350 ml/100 g.

6. The thermally sensitive recording medium according to claim 2, wherein the metallic compound is aluminum oxide.
